(19) United States
(12) Patent Application Publication
(10) Pub. No.: US 2025/0242493 A1
(43) Pub. Date: Jul. 31, 2025

(54) DETERMINATION OF CONSTRAINT FOR ROBOT CONTROL

(71) Applicant: KABUSHIKI KAISHA YASKAWA DENKI, Kitakyushu-shi (JP)

(72) Inventors: Ryo KABUTAN, Fukuoka (JP); Makoto TAKAHASHI, Fukuoka (JP)

(73) Assignee: KABUSHIKI KAISHA YASKAWA DENKI, Kitakyushu-shi (JP)

(21) Appl. No.: 19/007,671

(22) Filed: Jan. 2, 2025

(30) Foreign Application Priority Data
Jan. 26, 2024 (JP) 2024-010397

(51) Int. Cl. B25J 9/16

(52) U.S. Cl. CPC B25J 9/1661

(57) ABSTRACT

A robot system includes: a robot placed in a real working space and having a plurality of drive axes each having a degree of freedom for moving an end effector; and circuitry configured to: set a designated point in a task; virtually execute a simulated posture of the robot at the designated point by a simulation based on a robot model indicating the robot; calculate a degree of margin indicating how far the simulated posture is from a limit posture of the robot; determine a constraint condition of at least one of the plurality of drive axes at the designated point based on the calculated degree of margin; and control the robot based on the constraint condition.

### CROSS-REFERENCE TO RELATED APPLICATIONS

This application is based upon and claims the benefit of priority from Japanese Patent Application No. 2024-010397, filed on Jan. 26, 2024, the entire contents of which are incorporated herein by reference.

### BACKGROUND

### Field

One aspect of the present disclosure relates to a robot system, a robot control method, and a robot control program.

### Description of the Related Art

Japanese Patent No. 3902310 describes a posture generation method for an industrial robot in a case where a posture of a tool attached to the industrial robot has one redundant degree of freedom. Japanese Unexamined Patent Application Publication No. H05-220681 describes a robot control method that defines an evaluation function indicating a degree of approach to a blind spot caused by a wrist offset of a wrist part relative to a robot arm, determines a length or angle of a redundant axis such that a value of the evaluation function always becomes smaller, and determines a length or angle of other non-redundant axes based on the determined value to avoid the blind spot.

### SUMMARY

A robot system according to one aspect of the present disclosure includes: a robot placed in a real working space and having a plurality of drive axes each having a degree of freedom for moving an end effector; and circuitry configured to: set a designated point in a task; virtually execute a simulated posture of the robot at the designated point by a simulation based on a robot model indicating the robot; calculate a degree of margin indicating how far the simulated posture is from a limit posture of the robot; determine a constraint condition of at least one of the plurality of drive axes at the designated point based on the calculated degree of margin; and control the robot based on the constraint condition.

A processor-executable method according to one aspect of the present disclosure is for controlling a robot placed in a real working space and having a plurality of drive axes each having a degree of freedom for moving an end effector. The method includes: setting a designated point in a task; virtually executing a simulated posture of the robot at the designated point by a simulation based on a robot model indicating the robot; calculating a degree of margin indicating how far the simulated posture is from a limit posture of the robot; determining a constraint condition of at least one of the plurality of drive axes at the designated point based on the calculated degree of margin; and controlling the robot based on the constraint condition.

A non-transitory computer-readable storage medium according to one aspect of the present disclosure stores processor-executable instructions to cause a computer to function as a robot control system for controlling a robot placed in a real working space and having a plurality of drive axes each having a degree of freedom for moving an end effector. The instructions causes the computer to: set a designated point in a task; virtually execute a simulated posture of the robot at the designated point by a simulation based on a robot model indicating the robot; calculate a degree of margin indicating how far the simulated posture is from a limit posture of the robot; determine a constraint condition of at least one of the plurality of drive axes at the designated point based on the calculated degree of margin; and control the robot based on the constraint condition.

### BRIEF DESCRIPTION OF THE DRAWINGS

FIG. 1 is a diagram showing an example of a robot system.

FIG. 2 is a diagram showing an example functional configuration of a robot control system.

FIG. 3 is a diagram showing an example hardware configuration of a computer used for the robot control system.

FIG. 4 is a flowchart showing an example process executed by the robot system.

FIG. 5 is a diagram for explaining the setting of a designated point.

FIG. 6 is a diagram showing an example manipulability ellipsoid.

FIG. 7 is a diagram for explaining a process of determining a constraint condition common to two or more tasks.

### DETAILED DESCRIPTION

In the following description, with reference to the drawings, the same reference numbers are assigned to the same components or to similar components having the same function, and overlapping description is omitted.

### Overview of System

A robot system according to the present disclosure is a control system for appropriately operating a real robot including an end effector even in a case where a situation around the robot is different from a previous assumption. In some examples, the robot system includes one or more real robots placed in a real working space and a robot control system that is a computer system for controlling the robots.

The robot control system calculates, by simulation, a posture of the robot when the end effector is positioned at a designated point. In the present disclosure, that posture is referred to as a “simulated posture”. The simulation is a process that virtually represents an operation of the robot on a computer instead of actually operating the real robot. The designated point, which is the premise of the simulation, is, for example, a position where the end effector acts on a workpiece. The robot control system determines a constraint condition at the designated point for at least one of a plurality of drive axes of the robot, based on a degree of margin related to the simulated posture. The robot control system then controls the robot based on the constraint condition to position the end effector at the designated point. The robot control system may further control the robot with the end effector positioned at the designated point.

The degree of margin refers to an index indicating how far the simulated posture is from a limit posture of the robot. The limit posture refers to a posture in which the robot cannot operate properly. Examples of the limit posture include a singularity where the robot cannot be controlled in a calculation formula and a posture reaching a limit value of a movable range with respect to at least one drive axis. The constraint condition refers to a restriction that needs to be met when controlling the real robot.

In the simulation, the robot control system generates the simulated posture by virtually representing not only the operation of the robot but also the environment of the real working space. The robot control system then controls the real robot based on the simulated posture. However, in some cases, the actual environment may differ from the environment in the simulation. For example, the actual position of the workpiece may differ from the position assumed in the simulation, causing the coordinates of the actual designated point to deviate from the coordinates in the simulation. Therefore, the posture of the robot may be corrected from the simulated posture according to the actual environment and the real robot may be controlled such that the end effector positions at the actual designated point by the corrected posture.

However, if only work efficiency such as operation time and operation distance is considered in the simulation, the constraint condition may be determined based on a simulated posture close to the limit posture. As a result, in the real working space, there is a possibility that a pulse limit over occurs where the posture of the robot reaches the limit value of the movable range of the joint, or the motion of the robot passes through a singularity.

The robot control system determines the constraint condition considering the degree of margin obtained from the simulated posture and the limit posture. This process ensures that the posture of the robot for positioning the end effector at the designated point is a posture with a margin considering the possibility that the environment may differ between the real and the simulation, that is, a posture that may be corrected in real-time in the real working space. Therefore, even if the actual environment such as the position of the workpiece differs from the simulation, the difference may be absorbed, and the real robot may be appropriately operated.

### Configuration of System

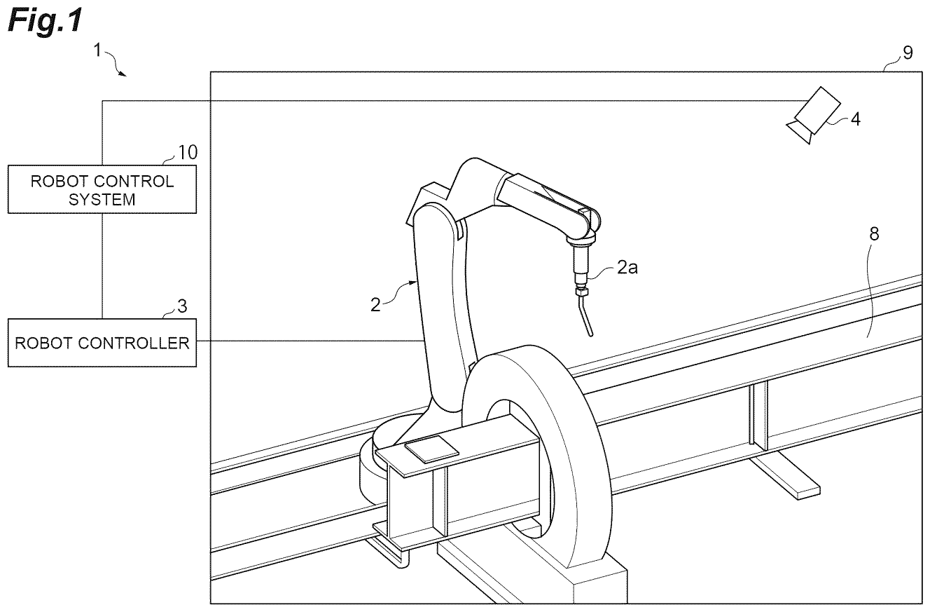

FIG. 1 is a diagram showing an example robot system. The robot system 1 shown in this example includes a real robot 2 placed in a real working space 9 to process a real workpiece 8, a robot control system 10 for controlling the robot 2, and a robot controller 3 for controlling the robot 2 based on instructions from the robot control system 10. The robot control system 10 is connected to the robot controller 3 and a camera 4 for capturing the working space 9 via a communication network. The communication network may be a wired network or a wireless network. The communication network may include at least one of the Internet and an intranet. Alternatively, the communication network may be implemented simply by a single communication cable.

In the example of FIG. 1, the workpiece 8 is H-steel, and the robot 2 performs welding in one or more predetermined working areas on the H-steel. The robot 2 is able to move on a rail provided along the H-steel. The robot 2 may be an autonomous mobile robot (AMR) or may be supported by an automated guided vehicle (AGV). The robot 2 may operate in cooperation with a positioner that holds the workpiece 8. In the example of FIG. 1, the robot system 1 treats the traveling axis along the rail as a redundant axis and determines a position on the redundant axis as the constraint condition.

The robot 2 is a device that receives power and performs a predetermined motion according to a purpose, thereby performing useful work. In some examples, the robot 2 includes a plurality of joints, an arm, and an end effector 2a attached to the tip of the arm. The robot 2 processes the workpiece using the end effector 2a. Examples of the end effector 2a include a welding gun and a screw fastening device. Each of the plurality of joints is provided with a drive axis (joint axis). Some components of the robot 2, such as the arm and a pivoting unit, rotate about the drive axis, so that the robot 2 is able to change the position and posture of the end effector 2a within a predetermined range. That is, the robot 2 has a plurality of drive axes each having a degree of freedom for moving the end effector 2a. In the present disclosure, the degree of freedom of the drive axis refers to the fact that the drive axis has a movable range defined by two limit values different from each other. In a case where the drive axis is a rotation axis, the degree of freedom may be indicated by the range of rotation angles. In a case where the drive axis is a traveling axis, the degree of freedom may be indicated by the range of reachable positions. Since the robot 2 has the plurality of drive axes each having the degree of freedom, the robot 2 may take various postures in a situation where the end effector 2a is positioned at the designated point. The robot 2 may include two or more arms each provided with the same or different end effector 2a.

In some examples, the robot 2 is a multi-axis serial link type vertical articulated robot. The robot 2 may be a six-axis vertical articulated robot, that is, a six-axis robot. Alternatively, the robot 2 may include a plurality of drive axes including a redundant axis. The robot 2 may be a vertical articulated robot with seven or more drive axes, for example, a seven-axis vertical articulated robot in which one redundant axis is added to six axes. As described above, the robot 2 may be a self-propelled movable robot, for example, an autonomous mobile robot (AMR), or a robot supported by an automated guided vehicle (AGV). Such a movable robot is an example of a robot in which the traveling axis is set as the redundant axis or a robot having the traveling axis as the drive axis. Such a movable robot may be a six-axis robot that may move along the traveling axis. Alternatively, the robot 2 may be a stationary robot fixed at a predetermined place.

The robot controller 3 is a device that controls the robot 2 according to an operation program generated in advance. In some examples, the robot controller 3 calculates a joint angle target value (angle target value of each joint of the robot 2) for matching the position and posture of the end effector 2a with a target value indicated by the operation program and controls the robot 2 according to the angle target value.

The camera 4 is a device that captures at least a part of the working space 9 and generates image data indicating the situation in the captured area. In some examples, the camera 4 captures at least the workpiece 8 present in the working space 9 and generates the image data indicating the actual position of the workpiece 8 as a workpiece position. The camera 4 transmits the image data to the robot control system 10. The camera 4 may be fixed to a column, ceiling, etc., or may be attached near the tip of the arm of the robot 2. The camera 4 is an example of a sensor that detects the actual position of the workpiece 8 present in the working space 9 as the workpiece position.

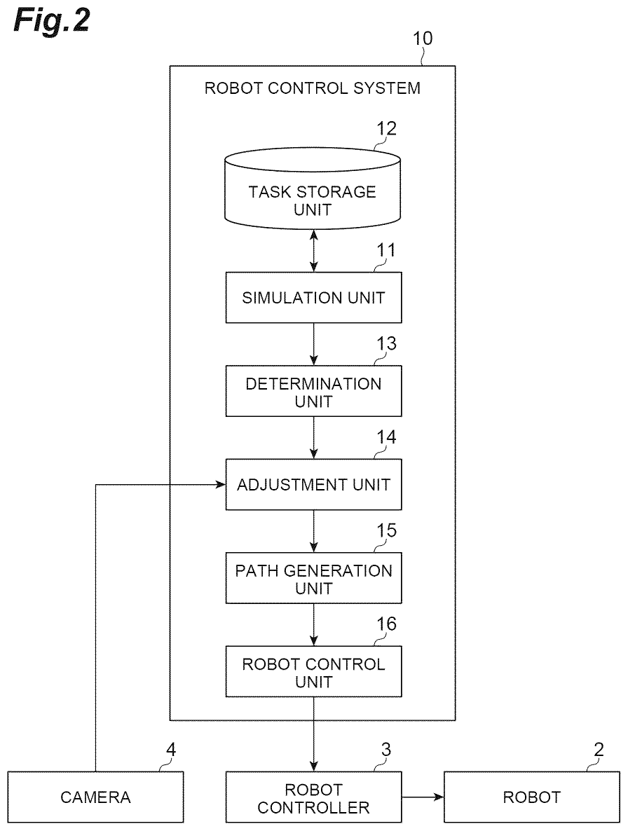

FIG. 2 is a diagram showing an example functional configuration of the robot control system 10. In this example, the robot control system 10 includes a simulation unit 11, a task storage unit 12, a determination unit 13, an adjustment unit 14, a path generation unit 15, and a robot control unit 16 as functional elements. The simulation unit 11 is a functional module that virtually executes the simulated posture of the robot 2 by the simulation. The task storage unit 12 is a functional module or storage that stores task information indicating tasks for processing the workpiece. The task refers to a work to be performed by the robot to achieve a certain purpose. The determination unit 13 is a functional module that determines the constraint condition at the designated point based on the degree of margin obtained from the simulated posture and the limit posture. The adjustment unit 14 is a functional module that adjusts the designated point based on the workpiece position detected by the camera 4. The path generation unit 15 is a functional module that generates a path for moving the end effector 2a to the adjusted designated point. The path refers to information indicating a trajectory that is a route of the movement of the robot 2 or a component thereof (e.g., the end effector 2a). The robot control unit 16 is a functional module that controls the robot 2 based on at least the constraint condition.

The robot control system 10 may be implemented by any type of computer. The computer may be a general-purpose computer such as a personal computer or a business server, or may be incorporated in a dedicated device that executes specific processing.

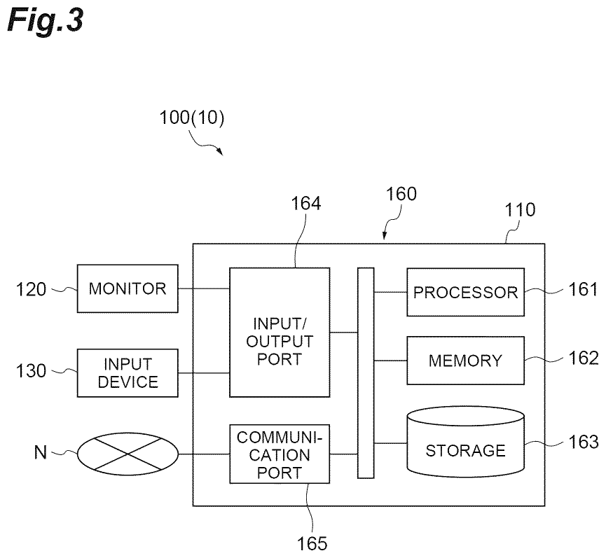

FIG. 3 is a diagram showing an example hardware configuration of a computer 100 used for the robot control system 10. In this example, the computer 100 includes a main body 110, a monitor 120, and an input device 130.

The main body 110 is a device having circuitry 160. The circuitry 160 has a processor 161, a memory 162, a storage 163, an input/output port 164, and a communication port 165. The number of each hardware component may be one or two or more. The storage 163 stores a program for configuring each functional module of the main body 110. The storage 163 is a computer-readable recording medium such as a hard disk, a nonvolatile semiconductor memory, a magnetic disk, or an optical disk. The memory 162 temporarily stores a program loaded from the storage 163, a calculation result of the processor 161, etc. The processor 161 configures each functional module by executing the program in cooperation with the memory 162. The input/output port 164 inputs and outputs electrical signals to and from the monitor 120 or the input device 130 in response to commands from the processor 161. The communication port 165 performs data communication with other devices such as the robot controller 3 via a communication network N in accordance with commands from the processor 161.

The monitor 120 is a device for displaying information output from the main body 110. For example, the monitor 120 is a device capable of graphic display, such as a liquid-crystal panel.

The input device 130 is a device for inputting information to the main body 110. Examples of the input device 130 include operation interfaces such as a keypad, a mouse, and a manipulation controller.

The monitor 120 and the input device 130 may be integrated as a touch panel. For example, the main body 110, the monitor 120, and the input device 130 may be integrated as a tablet computer.

Each functional module in the robot control system 10 is implemented by loading a robot control program on the processor 161 or the memory 162 and executing the program in the processor 161. The robot control program includes codes for implementing each functional module of the robot control system 10. The processor 161 operates the input/output port 164 and the communication port 165 according to the robot control program, and executes reading and writing of data in the memory 162 or the storage 163.

The robot control program may be provided by being recorded in a non-transitory recording medium such as a CD-ROM, a DVD-ROM, or a semiconductor memory. Alternatively, the robot control program may be provided via a communication network as data signals superimposed on carrier waves.

### Robot Control Method

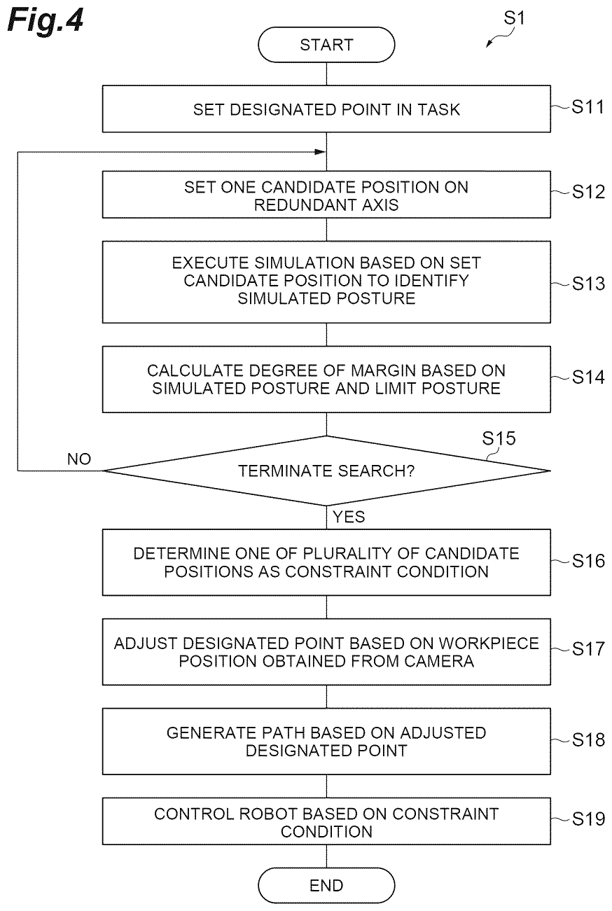

As an example of the robot control method according to the present disclosure, an example of processing executed by the robot system 1 will be described with reference to FIG. 4. FIG. 4 is a flowchart showing that example as a processing flow S1. That is, the robot system 1 performs the processing flow S1.

In step S11, the simulation unit 11 sets a designated point in a task. In some examples, the simulation unit 11 reads, from the task storage unit 12, task information of the task to be simulated and sets the designated point in the task based on the task information. For example, the simulation unit 11 sets each of one or more positions where the end effector 2a acts on the workpiece 8 in the task, as the designated points.

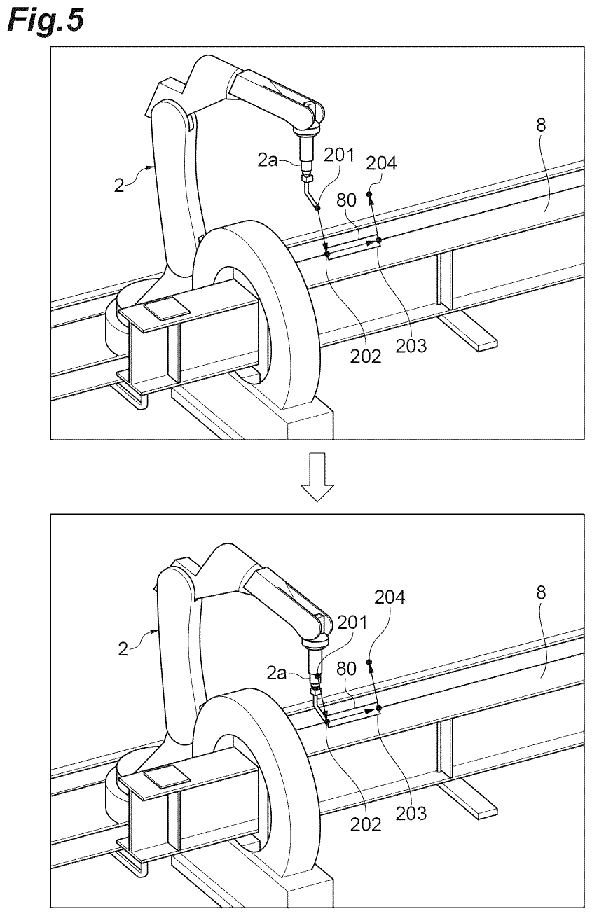

FIG. 5 is a diagram for explaining the setting of the designated point. In this example, the task is to weld a linear working area 80 on the workpiece 8. The task information includes an approach point 201, a start point 202, an end point 203, and a retraction point 204 that are set to perform the welding. The path of the end effector 2a in the task extends from the approach point 201 through the start point 202 and the end point 203 to the retraction point 204. In the present disclosure, the approach point refers to the starting point of the task path. The start point refers to the position where the end effector starts to act on the workpiece (working area). The end point refers to the position where the action of the end effector on the workpiece (working area) ends. The retraction point refers to the end point of the task path. The approach point and the retraction point are set slightly away from the workpiece (working area), and the start point and the end point are set on the workpiece (working area). In some examples, the simulation unit 11 sets at least the start point 202 as the designated point. The simulation unit 11 may set the end point 203 as the designated point in addition to the start point 202, or may set one or more relay points on the working area 80 between the start point 202 and the end point 203 as the designated points. In any case, the designated point is a position where the end effector acts on the workpiece 8.

Returning to FIG. 4, in step S12, the simulation unit 11 sets one candidate position on the redundant axis. As described above, the redundant axis may be the traveling axis of a six-axis robot or the redundant axis of a seven-axis robot. In the example of FIG. 1, the simulation unit 11 treats the traveling axis as the redundant axis and sets the candidate position on this redundant axis.

In some examples, the simulation unit 11 uses a robot model indicating the robot 2 having the end effector 2a and a workpiece model indicating the workpiece 8 for the setting. Both of these models are represented by electronic data. The robot model indicates specifications for the robot 2 and the end effector 2a. The specifications may include parameters related to structures of the robot 2 and the end effector 2a, such as shape and dimensions, and parameters related to functions of the robot 2 and the end effector 2a, such as the movable range of each joint and the performance of the end effector 2a. The workpiece model may indicate one or more working areas on the workpiece 8, the processing order of the one or more working areas, and other attributes of the workpiece 8, such as shape and dimensions.

The simulation unit 11 generates a virtual space corresponding to the real working space 9, generates a virtual workpiece 8 based on the workpiece model, and generates a virtual robot 2 based on the robot model. The simulation unit 11 places the generated workpiece 8 and robot 2 in the virtual space. The simulation unit 11 sets the redundant axis of the robot 2 and sets one candidate position on the redundant axis. In some examples, the simulation unit 11 sets the candidate position by an optimization method that optimizes the position on the redundant axis. The simulation unit 11 may use Bayesian optimization as the optimization method. The simulation unit 11 uses Gaussian process regression to estimate a function indicating the relationship between the candidate position and an evaluation value and calculate a variance indicating the uncertainty of the function. The simulation unit 11 uses the evaluation value that reflects at least the degree of margin. The simulation unit 11 may use the evaluation value that further reflects a physical quantity related to the operation of the robot 2 in addition to the degree of margin. Examples of the physical quantity include the distance or time required for the operation (so-called playback time). The simulation unit 11 calculates a predetermined acquisition function based on the result of the Gaussian process regression. The simulation unit 11 sets the candidate position where the acquisition function is maximized as a new candidate position. As other examples, the simulation unit 11 may set the candidate positions at predetermined intervals or may set the candidate positions randomly.

In step S13, the simulation unit 11 executes the simulation based on the set candidate position to identify a simulated posture. As described above, the simulated posture is a posture of the robot 2 in a case where the end effector 2a is positioned at the designated point. The simulation unit 11 virtually executes the simulated posture by the simulation based on the robot model.

The simulation unit 11 may virtually execute, by the simulation, a work scene in which the robot 2 positions the end effector 2a at the start point of the task by the simulated posture to process the workpiece 8. In the example of FIG. 5, the simulation unit 11 virtually operates the robot 2 such that the end effector 2a passes through the approach point 201, the start point 202, the end point 203, and the retraction point 204 in this order, and virtually executes the work scene in which the robot 2 welds the working area 80. The simulation unit 11 identifies the simulated posture at each of the one or more designated points by the simulation. For example, the simulation unit 11 identifies at least the simulated posture at the start point 202 and may further identify the simulated posture(s) at the end point 203 or the relay points. That is, the simulation unit 11 may identify a plurality of the simulated postures in the working area 80.

In step S14, the determination unit 13 calculates the degree of margin based on the simulated posture and the limit posture.

In some examples, the determination unit 13 may calculate the degree of margin based on the simulated posture and the median of the movable range of each of the plurality of drive axes (joints) of the robot 2, that is, the median of the joint angles of each drive axis. The degree of margin z in this example may be defined by the following equation (1).

$$[ Equation 1 ]$$

$$\begin{matrix}z = \frac{1}{2} {( θ - \overline{θ} )}^{T} {W}^{T} W ( θ - \overline{θ} ) \\ where \overline{θ} ≡ \frac{1}{2} ( {θ}_{max} + {θ}_{min} ) , W ≡ Diag ( w )\end{matrix} \qquad ( 1 )$$

The θ is a vector indicating an angle of each drive axis of the robot 2 in the simulated posture, and the
θ̅
is a vector indicating the median angle of each drive axis of the robot 2. The θₘₐₓ and θₘᵢₙ are vectors indicating the upper and lower limits of the movable range of each drive axis, respectively, and thus indicate the limit postures. The variable W is a diagonal matrix indicating the weight w of each drive axis.

In equation (1), the degree of margin z becomes smaller as the simulated posture approaches the median of the joint angle, that is, as the simulated posture moves away from the limit posture.

As another example, the determination unit 13 may evaluate how far the simulated posture is from a singularity, that is, the distance between the simulated posture and the singularity, using the concept of manipulability ellipsoid, and calculate the evaluation value as the degree of margin. The manipulability ellipsoid is an ellipsoid that indicates how easily the hand (end effector 2a) of the robot 2 is able to move in each direction in the orthogonal space. The manipulability ellipsoid indicates that the hand is able to move more easily in the direction where the width of the ellipsoid is wider. The volume of the manipulability ellipsoid indicates the closeness (distance) from the singularity. A posture where the width of the manipulability ellipsoid in a certain direction is zero, that is, a posture where the volume of the manipulability ellipsoid is zero, is the singularity.

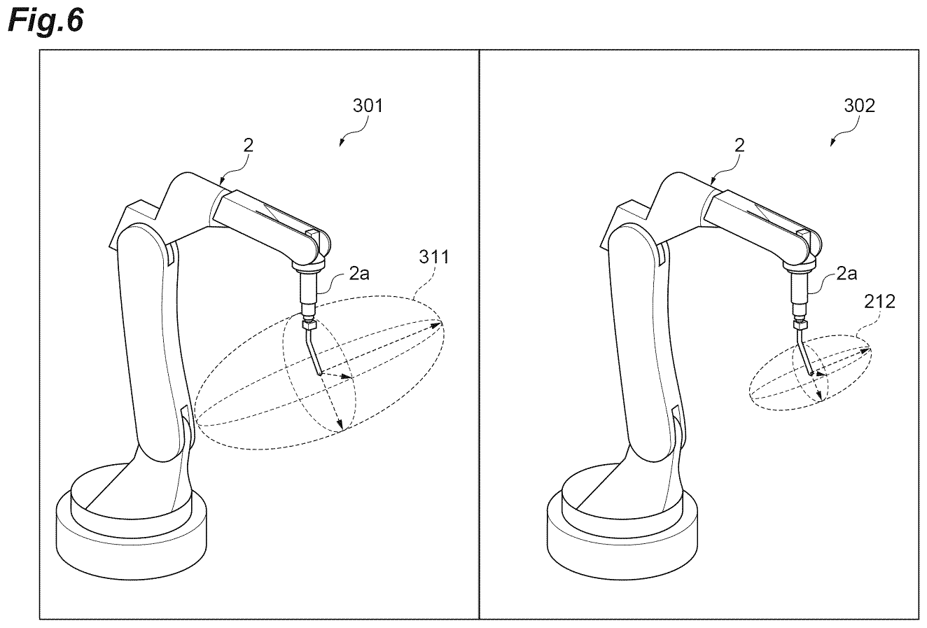

FIG. 6 is a diagram showing an example manipulability ellipsoid. In this example, a manipulability ellipsoid 311 corresponding to the posture of the robot 2 in a scene 301 and a manipulability ellipsoid 312 corresponding to the posture of the robot 2 in a scene 302 are shown. The center of each manipulability ellipsoid is the tip of the end effector 2a. The manipulability ellipsoid 311 in the scene 301 is relatively large, indicating that the posture of the robot 2 is far from the singularity and a margin for changing the posture is relatively large. On the other hand, the manipulability ellipsoid 312 in scene 302 is relatively small, indicating that the posture of the robot 2 is close to the singularity and the margin for changing the posture is relatively small.

The manipulability ellipsoid is calculated using the Jacobian matrix J obtained from the kinematics information and posture information of the robot 2. The determination unit 13 calculates the Jacobian matrix J based on the robot model and the simulated posture. The determination unit 13 then executes singular value decomposition on the Jacobian matrix J. The singular value decomposition is represented by the following equation (2).

$$[ Equation 2 ]$$

$$J = U \sum {V}^{T} , \sum ≡ Diag ( {σ}_{1} , {σ}_{2} , … , {σ}_{m} ) \qquad ( 2 )$$

The U and V are orthogonal matrices, and Σ is a diagonal matrix indicating each singular value σ.

The determination unit 13 calculates the degree of margin ω using each singular value σ indicated by the matrix Σ by the following equation (3).

$$[ Equation 3 ]$$

$$ω = \sqrt{\frac{1}{{σ}_{1} , {σ}_{2} … {σ}_{m}}} \qquad ( 3 )$$

The product of the singular values σ becomes larger as the manipulability ellipsoid becomes larger. Therefore, in equation (3), the degree of margin ω becomes smaller as the manipulability ellipsoid becomes larger, that is, as the simulated posture moves away from the limit posture (singularity).

The determination unit 13 may calculate the degree of margin from the simulated posture and the limit posture at the start point. Alternatively, the determination unit 13 may calculate the degree of margin based on the simulated posture and the limit posture at each of two or more positions including the start point and calculate a statistical value (e.g., average value) of the calculated two or more degrees of margin as the final degree of margin. That is, the simulation unit 11 may calculate the degree of margin in the simulated work scene based on a plurality of degrees of margin in the area from the start point to the end point.

In step S15, the determination unit 13 determines whether to terminate the search for candidate positions and simulated postures based on a predetermined termination condition. The termination condition may be that a predetermined number of candidate positions have been set or that a predetermined calculation time has elapsed. In a case of setting candidate positions by the optimization method, the termination condition may be that the difference between the evaluation value obtained last time and the evaluation value obtained this time is less than a predetermined threshold, that is, the evaluation value has stagnated or converged. Alternatively, the termination condition may be that an evaluation value meeting a predetermined criterion has been obtained. Alternatively, the termination condition may be that the uncertainty (e.g., variance) of the entire relationship between the candidate positions and the evaluation values has become less than a predetermined threshold.

In a case where the search is to be continued (NO in step S15), the process returns to step S12. In repeated step S12, the simulation unit 11 sets a new candidate position on the redundant axis. In repeated step S13, the simulation unit 11 executes the simulation based on the candidate position and identifies a new simulated posture. In repeated step S14, the determination unit 13 calculates the degree of margin for the new simulated posture.

As described with respect to step S15, the simulation unit 11 virtually executes the simulated posture for each of the plurality of candidate positions set on the redundant axis. The determination unit 13 calculates the degree of margin for each of the plurality of candidate positions based on the simulated posture at each candidate position and the limit posture.

In a case where the search is to be terminated (YES in step S15), the process proceeds to step S16. In step S16, the determination unit 13 determines one of the plurality of candidate positions as the constraint condition at the designated point based on the degree of margin for each of the plurality of candidate positions. As described above, in some examples, the designated point is a position where the end effector 2a acts on the workpiece 8. The determination unit 13 may therefore determine the constraint condition for the end effector 2a to act on the workpiece 8. The candidate position determined as the constraint condition is one position on the redundant axis. For example, the determination unit 13 determines the candidate position where the simulated posture farthest from the limit posture is obtained, as the constraint condition. In a case of using the above equation (1), the determination unit 13 determines the candidate position where the smallest degree of margin z is obtained, as the constraint condition. In a case of using the above equations (2) and (3), the determination unit 13 determines the candidate position where the smallest degree of margin ω is obtained, as the constraint condition.

In step S17, the adjustment unit 14 adjusts the designated point based on a workpiece position obtained from the camera 4. The adjustment unit 14 analyzes image data transmitted from the camera 4 and identifies the workpiece position in the working space 9 detected by the camera 4. The adjustment unit 14 then adjusts the designated point used in the simulation, based on the identified workpiece position. For example, as such an adjustment, the adjustment unit 14 calculates the difference between the coordinates of the designated point in the simulation and the coordinates of the workpiece position indicated by the image data and adjusts the coordinates of the designated point based on the difference such that the designated point matches the workpiece position.

In step S18, the path generation unit 15 generates a path based on the adjusted designated point. In some examples, the path generation unit 15 generates a path for moving the end effector 2a to the adjusted designated point. The generated path may be an air-cut path, which is a path in the air-cut that is a process of guiding the robot 2 to the position to start a task. The path generation unit 15 generates the path such that the robot 2 is able to continue to take normal postures (i.e., the robot 2 operates normally) and no interference is detected. The interference refers to a phenomenon in which an object contacts or collides with an object other than the workpiece 8. It should be noted that in a case where the robot 2 attempts to process the workpiece 8, the contact between the robot 2 and the workpiece 8 is not the interference.

In step S19, the robot control unit 16 controls the real robot 2 in the working space 9 based on the constraint condition. The robot control unit 16 controls the position or posture of the robot 2 such that the robot 2 meets the constraint condition in the drive axis where the constraint condition is set. The robot control unit 16 generates an operation program for controlling the real robot 2 based on the constraint condition. The operation program includes data for controlling the robot 2, for example, the path. In some examples, the robot control unit 16 generates an operation program that causes the robot 2 to move along the generated path and position the end effector 2a at the designated point.

The robot control unit 16 controls the robot 2 to process the real workpiece 8, based on the constraint condition and the workpiece position detected by the camera 4. That is, the robot control unit 16 controls the robot 2 based on not only the constraint condition but also the actual position of the workpiece 8 in the working space 9. For example, the robot control unit 16 controls the robot 2 so as to process the workpiece 8 based on the adjusted designated point. In this case, the robot control unit 16 generates an operation program that causes the robot 2 to move along the generated path and position the end effector 2a at the adjusted designated point. The robot control unit 16 may generate or update the operation program so as to replace the coordinates of the designated point in the simulation with the coordinates of the adjusted designated point. This operation program enables the end effector 2a to be accurately positioned on the real workpiece 8.

The robot control unit 16 controls the real robot 2 based on the operation program. The robot control unit 16 outputs the operation program to the robot controller 3 to cause the robot controller 3 to control the robot 2. The robot controller 3 operates the robot 2 based on the operation program. As a result, the robot 2 operates according to the position or posture that meets the constraint condition, and in some examples, accurately positions the end effector 2a at the actual position of the workpiece 8. The operation program may be generated based on the adjusted designated point. Therefore, the actual posture of the robot 2 that has positioned the end effector 2a at the actual coordinates corresponding to the designated point may differ from the simulated posture.

The robot control unit 16 may further output to the robot controller 3 an operation program to cause the robot 2 to execute the task from the designated point. The robot controller 3 operates the robot 2 based on the operation program, and as a result, the robot 2 executes the task.

The robot system 1 may also execute the processing flow S1 to determine a constraint condition common to two or more tasks. Hereinafter, that constraint condition is simply referred to as a “common constraint condition”. In a case of determining the common constraint condition, the task storage unit stores the task information for each of the two or more tasks.

In step S11, the simulation unit 11 sets one or more designated points for each of the two or more tasks based on the task information.

In step S12, the simulation unit 11 sets one candidate position on the redundant axis as a common position that is the same position among the two or more tasks. That candidate position (common position) is a position that is fixed without changing among the two or more tasks.

In step S13, the simulation unit 11 executes the simulation based on the set candidate position to identify the simulated posture. The simulation unit 11 virtually executes the work scene including the two or more tasks by the simulation in a situation where the candidate position on the redundant axis is fixed (i.e., without changing the candidate position).

In step S14, the determination unit 13 calculates the degree of margin based on the simulated posture and the limit posture, for each of the two or more tasks.

As indicated by step S15, the processing of steps S12 to S14 may be repeated also in a case of determining the common constraint condition.

In step S16, the determination unit 13 determines the common constraint condition based on the degree of margin for each of the two or more tasks. For example, the determination unit 13 may calculate a statistical value (e.g., average value) of the two or more degrees of margin corresponding to the two or more tasks, for each of the plurality of candidate positions, and determine the candidate position where the simulated posture farthest from the limit posture is obtained statistically, as the common constraint condition.

In step S17, the adjustment unit 14 adjusts the designated points for each of the two or more tasks based on the workpiece position obtained from the camera 4.

In step S18, the path generation unit 15 generates a path for sequentially processing the two or more tasks, based on each of the adjusted designated points. For example, the path generation unit 15 generates an air-cut path between two adjacent tasks such that the two or more tasks from the first task to the last task to be processed under the common constraint condition are connected by a continuous path.

In step S19, the robot control unit 16 controls the real robot 2 in the working space 9 based on the common constraint condition. The robot control unit 16 outputs the operation program to the robot controller 3 to cause the robot controller 3 to operate the robot 2. By this control, the robot 2 operates according to the position or posture that meets the common constraint condition and performs each of the two or more tasks according to the actual position of the workpiece 8.

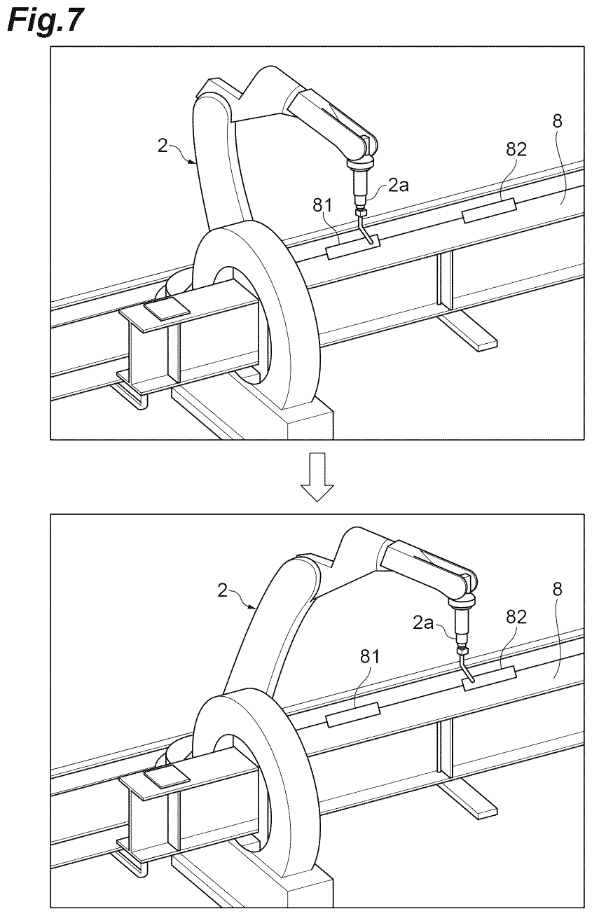

An example of the process of determining the common constraint condition will be described with further reference to FIG. 7. FIG. 7 is a diagram for explaining that process. In this example, the simulation unit 11 sets one or more designated points in a first task for welding a first working area 81 of the workpiece 8 and one or more designated points in a second task for welding a second working area 82 of the workpiece 8 (step S11). The simulation unit 11 processes the traveling axis as the redundant axis and sets a candidate position common to both the first task and the second task on that redundant axis (step S12). The simulation unit 11 executes the simulation based on the candidate position (step S13). The simulation unit 11 virtually executes a first work scene in which the robot 2 positions the end effector 2a at the start point (designated point) in the first task by a first simulated posture and welds the first working area 81. The simulation unit 11 further virtually executes a second work scene in which the robot 2 positions the end effector 2a at the start point (designated point) in the second task by a second simulated posture and welds the second working area 82. FIG. 7 shows these two consecutive tasks. The determination unit 13 calculates the degree of margin for each of the first task and the second task (step S14).

After terminating the search while changing the candidate positions (YES in step S15), the determination unit 13 determines the common constraint condition based on the degree of margin for each of the first task and the second task (step S16). The adjustment unit 14 adjusts the designated points for each of the first task and the second task (step S17). The path generation unit 15 generates a path for sequentially processing the first task and the second task based on each of the adjusted designated points (step S18). The robot control unit 16 causes the real robot 2 to perform the first task and the second task based on the common constraint condition (step S19). As a result, the robot 2 operates according to the actual position of the workpiece 8 and accurately welds the first working area 81 and the second working area 82.

### Additional Examples

It is to be understood that not all aspects, advantages and features described herein may necessarily be achieved by, or included in, any one particular example. Indeed, having described and illustrated various examples herein, it should be apparent that other examples may be modified in arrangement and detail.

In the above examples, the camera 4 detects the workpiece position, but other types of sensors such as a laser sensor may detect the workpiece position.

In the above examples, the robot system 1 (robot control system 10) controls the robot 2 based on the workpiece position, but the robot system may not include such a function. Related to this modification, the robot system may not adjust the designated point based on the workpiece position. Therefore, the robot system may not include a functional module corresponding to the adjustment unit 14. Related to this, the robot system may not include a functional module corresponding to the path generation unit 15.

The simulation unit may not virtually execute the work scene in which the robot processes the workpiece, i.e., the task. Therefore, the robot system may not include a functional module corresponding to the task storage unit 12.

The robot system (robot control system) may determine the constraint condition to control two or more robots that operate cooperatively. Each of the two or more robots has one or more drive axes. Therefore, the robot system includes two or more robots each having one or more drive axes, as a robot having a plurality of drive axes. For example, the robot system may include a main robot that performs a main task such as welding or painting on the workpiece and an auxiliary robot that supports or moves the workpiece for the main task. Each of the main robot and the auxiliary robot has any number of drive axes. For example, the main robot may be a six-axis robot or a seven-axis robot. Examples of the auxiliary robot include a positioner having one, two, or three axes and a robot having four or more axes.

In such examples related to cooperative operation, the robot system virtually executes the posture of each robot in a case where the end effector of one of the two or more robots is positioned at the designated point, as the simulated posture of each robot in the cooperative operation. For each robot, the robot system calculates the degree of margin obtained from the simulated posture and the limit posture and determines the constraint condition based on each degree of margin. The robot system may set a drive axis of one of the two or more robots in the cooperative operation as the redundant axis and determine one position on the redundant axis as the constraint condition. For example, the robot system may set one of the one or more drive axes of the main robot or one of the one or more drive axes of the auxiliary robot as the redundant axis, and determine one position on the redundant axis as the constraint condition. The above processing flow S1 may also be used in a case of determining the constraint condition in the cooperative operation and controlling each robot.

The hardware configuration of the system is not limited to a manner in which each functional module is realized by executing a program. For example, at least part of the above-described functional modules may be configured by a logic circuit specialized for the function(s), or may be configured by an application-specific integrated circuit (ASIC) in which the logic circuits are integrated.

The processing procedure of the method executed by the at least one processor is not limited to the above examples. For example, some of the steps or processes described above may be omitted, or the steps may be executed in a different order. In addition, any two or more of the above-described steps may be combined, or some of the steps may be modified or deleted. Alternatively, another step may be executed in addition to the above-described steps.

In a case where a magnitude relationship between two numerical values is compared in a computer system or a computer, either of two criteria of “equal to or greater than” and “greater than” may be used, and either of two criteria of “equal to or less than” and “less than” may be used.

As described above, a robot system according to one aspect of the present disclosure includes: a robot placed in a real working space and having a plurality of drive axes each having a degree of freedom for moving an end effector; and circuitry configured to: set a designated point in a task; virtually execute a simulated posture of the robot at the designated point by a simulation based on a robot model indicating the robot; calculate a degree of margin indicating how far the simulated posture is from a limit posture of the robot; determine a constraint condition of at least one of the plurality of drive axes at the designated point based on the calculated degree of margin; and control the robot based on the constraint condition.

A processor-executable method according to one aspect of the present disclosure is for controlling a robot placed in a real working space and having a plurality of drive axes each having a degree of freedom for moving an end effector. The method includes: setting a designated point in a task; virtually executing a simulated posture of the robot at the designated point by a simulation based on a robot model indicating the robot; calculating a degree of margin indicating how far the simulated posture is from a limit posture of the robot; determining a constraint condition of at least one of the plurality of drive axes at the designated point based on the calculated degree of margin; and controlling the robot based on the constraint condition.

A non-transitory computer-readable storage medium according to one aspect of the present disclosure stores processor-executable instructions to cause a computer to function as a robot control system for controlling a robot placed in a real working space and having a plurality of drive axes each having a degree of freedom for moving an end effector. The instructions causes the computer to: set a designated point in a task; virtually execute a simulated posture of the robot at the designated point by a simulation based on a robot model indicating the robot; calculate a degree of margin indicating how far the simulated posture is from a limit posture of the robot; determine a constraint condition of at least one of the plurality of drive axes at the designated point based on the calculated degree of margin; and control the robot based on the constraint condition.

In some aspects, the simulated posture of the robot, which is a posture when the end effector is positioned at the designated point, is obtained by the simulation. Then, based on the degree of margin obtained from the simulated posture and the limit posture of the robot, the constraint condition of at least one drive axis imposed when controlling the robot is determined. Since the constraint condition of the robot is determined considering the degree of margin, the posture of the robot may be corrected according to the actual situation and the end effector may be positioned at the designated point as planned, even in a case where the actual situation around the real robot differs from a previous assumption. That is, a real robot may be operated appropriately even in a case where a situation around the robot is different from a previous assumption.

In some examples, the circuitry may be configured to control a position or posture of the robot such that the robot meets the constraint condition in the at least one drive axis.

In some examples, the plurality of drive axes may include a redundant axis, and the circuitry may be configured to determine one position on the redundant axis as the constraint condition. Since the position on the redundant axis is determined as the constraint condition, each of the one or more drive axes other than the redundant axis, which are directly related to the basic operation of the robot, may be corrected according to an actual situation. Therefore, the end effector may be positioned at the designated point as planned.

In some examples, the robot system may further include a sensor configured to detect a real position of a workpiece present in the real working space as a workpiece position, and the circuitry may be configured to control the robot to process the workpiece, based on the constraint condition and the workpiece position detected by the sensor. In this case, the robot is controlled so as to process the workpiece under the constraint condition, in consideration of the actual position of the actual workpiece (i.e., workpiece position) to be processed by the robot in addition to the constraint conditions determined based on the simulation. The actual situation may differ from the situation assumed in the simulation, for example, the actual position of the actual workpiece may differ from the position assumed in the simulation. By detecting the actual position of the actual workpiece as the workpiece position with the sensor and referring to the workpiece position, the posture of the robot may be accurately aligned with the workpiece position and the end effector may be positioned at the designated point as planned.

In some examples, the circuitry may be configured to: adjust the designated point based on the workpiece position detected by the sensor; and control the robot to process the workpiece, based on the adjusted designated point. In this case, the designated point where the end effector is to be positioned is adjusted based on the actual position of the actual workpiece (i.e., workpiece position), and the robot is controlled based on the adjusted designated point. Since the designated point used in the simulation is corrected based on the workpiece position, the end effector may be positioned at the designated point as planned.

In some examples, the circuitry may be configured to generate a path for moving the end effector to the adjusted designated point. Since a path for moving the end effector to the adjusted designated point is generated, the actual end effector may be reliably guided to the designated point.

In some examples, the circuitry may be configured to: set a position where the end effector acts on the workpiece as the designated point; and adjust the designated point based on a difference between coordinates of the designated point and coordinates of the workpiece position.

In some examples, the robot system may further include a storage configured to store a task for processing the workpiece, and the circuitry may be configured to: set a start position that is a position where the end effector starts to act on the workpiece in the task, as the designated point; virtually execute a work scene in which the robot positions the end effector at the start position by the simulated posture to process the workpiece, by the simulation; and determine the constraint condition for the end effector to act on the workpiece. In this case, the start point, which is the position where the end effector starts to act on the workpiece in the task, is set as the designated point, and the execution of the task based on that setting is simulated. Then, based on the result of the simulation, the constraint condition for the end effector to act on the workpiece is determined. Since the constraint condition is determined considering not only the simulated posture but also the entire task (i.e., the entire processing of the workpiece), the actual task may be completed while correcting the posture of the robot according to the actual situation.

In some examples, the circuitry may be configured to: virtually operate the robot such that the end effector passes through the start position and an end position in this order, and virtually execute the work scene, wherein the end position is a position where the action of the end effector on the workpiece ends in the task; and calculate the degree of margin in the work scene based on a plurality of the degrees of margin in an area from the start position to the end position.

In some examples, the storage may store two or more of the tasks, and the circuitry may be configured to: set the designated point for each of the two or more tasks; virtually execute the work scene including the two or more tasks in a state where a position of each of the at least one of the plurality of drive axes is fixed at a common position that is a same position among the two or more tasks; and determine the constraint condition common to the two or more tasks based on the degree of margin in each of the two or more tasks. In this case, each of the two or more tasks is simulated, and the constraint condition common to the two or more tasks (i.e., common constraint condition) is determined based on the degree of margin in each task. Since the common constraint condition is determined considering, for each task, not only the simulated posture but also the whole of the task, the two or more actual tasks may be efficiently completed while correcting the posture of the robot according to the actual situation.

In some examples, the circuitry may be configured to: virtually execute the simulated posture for each of a plurality of candidate positions set on the redundant axis; calculate the degree of margin for each of the plurality of candidate positions based on the simulated posture for each of the plurality of candidate positions and the limit posture; and determine one candidate position among the plurality of candidate positions as the constraint condition based on the degree of margin for each of the plurality of candidate positions. In this case, the degree of margin is calculated for each candidate position while changing the candidate positions, and one candidate position is determined as the constraint condition based on the degree of margin for each of the plurality of candidate positions. By such a search process, the constraint condition may be more reliably determined that allows the robot to be appropriately operated even in a case where a situation around the real robot differs from the previous assumption.

In some examples, the circuitry may be configured to: set each of the plurality of candidate positions by Bayesian optimization based on an evaluation value reflecting at least the degree of margin; and virtually execute the simulated posture for each of the set plurality of candidate positions.

In some examples, the circuitry may be configured to determine, among the plurality of candidate positions, the one candidate position where the simulated posture farthest from the limit posture is obtained, as the constraint condition.

In some examples, the circuitry may be configured to calculate the degree of margin based on the simulated posture and a median of a movable range of each of the plurality of drive axes.

In some examples, the circuitry may be configured to calculate a manipulability ellipsoid based on the robot model and the simulated posture, and calculate the degree of margin based on the manipulability ellipsoid.

In some examples, the robot may have a traveling axis as the drive axis, and the redundant axis may be the traveling axis. In this case, since the position on the traveling axis is determined as the constraint condition, each of the remaining drive axes, which are directly related to the basic operation of the robot, may be corrected according to the actual situation. Therefore, the end effector may be positioned at the designated point as planned.

In some examples, the robot may be a vertical articulated robot, the robot may have seven or more drive axes as the plurality of drive axes, and the redundant axis may be one of the seven or more drive axes. In this case, since the position on one drive axis of a vertical articulated robot having seven or more drive axes is determined as the constraint condition, each of the remaining drive axes, which are directly related to the basic operation of the robot, may be corrected according to the actual situation. Therefore, the end effector may be positioned at the designated point as planned.

In some examples, the robot may be two or more robots that operate cooperatively, each of the two or more robots may have one or more of the drive axes, and the redundant axis may be the drive axis of one of the two or more robots in the cooperative operation. In this case, in the cooperative operation of two or more robots, the position on one drive axis of one robot is determined as the constraint condition. As a result, each of the remaining drive axes, which are directly related to the basic operation of each robot in the cooperative operation, may be corrected according to the actual situation. Therefore, the end effector may be positioned at the designated point as planned in the cooperative operation.

We claim all modifications and variations coming within the spirit and scope of the subject matter claimed herein.

Regarding the above examples, the following appendices are provided by way of further illustration.

(Appendix 1) A robot system comprising:
a robot placed in a real working space and having a plurality of drive axes each having a degree of freedom for moving an end effector;
a simulation unit configured to virtually execute a simulated posture of the robot at a designated point by a simulation based on a robot model indicating the robot;
a determination unit configured to determine a constraint condition of at least one of the plurality of drive axes at the designated point based on a degree of margin obtained from the simulated posture and a limit posture of the robot; and
a robot control unit configured to control the robot based on the constraint condition.

(Appendix 2) The robot system according to appendix 1,
wherein the plurality of drive axes includes a redundant axis, and
wherein the determination unit is configured to determine one position on the redundant axis as the constraint condition.

(Appendix 3) The robot system according to appendix 1 or 2, further comprising a sensor configured to detect a real position of a workpiece present in the real working space as a workpiece position,
wherein the robot control unit is configured to control the robot to process the workpiece based on the constraint condition and the workpiece position detected by the sensor.

(Appendix 4) The robot system according to appendix 3, further comprising an adjustment unit configured to adjust the designated point based on the workpiece position detected by the sensor,
wherein the robot control unit is configured to control the robot to process the workpiece, based on the adjusted designated point.

(Appendix 5) The robot system according to appendix 4, further comprising a path generation unit configured to generate a path for moving the end effector to the adjusted designated point.

(Appendix 6) The robot system according to any one of appendices 1 to 5, further comprising a task storage unit configured to store a task for processing a workpiece,
wherein the simulation unit is configured to:
   set a start position that is a position where the end effector starts to act on the workpiece in the task, as the designated point; and
   virtually execute a work scene in which the robot positions the end effector at the start position by the simulated posture to process the workpiece, by the simulation; and
wherein the determination unit is configured to determine the constraint condition for the end effector to act on the workpiece.

(Appendix 7) The robot system according to appendix 6,
wherein the task storage unit stores two or more of the tasks, and
wherein the simulation unit is configured to:
   set the designated point for each of the two or more tasks; and
   virtually execute the work scene including the two or more tasks in a state where a position of each of the at least one of the plurality of drive axes is fixed at a common position that is the same position among the two or more tasks; and
wherein the determination unit is configured to determine the constraint condition common to the two or more tasks based on the degree of margin in each of the two or more tasks.

(Appendix 8) The robot system according to appendix 2,
wherein the simulation unit is configured to virtually execute the simulated posture for each of a plurality of candidate positions set on the redundant axis, and
wherein the determination unit is configured to:
   calculate the degree of margin for each of the plurality of candidate positions based on the simulated posture for each of the plurality of candidate positions and the limit posture; and
   determine one of the plurality of candidate positions as the constraint condition based on the degree of margin for each of the plurality of candidate positions.

(Appendix 9) The robot system according to appendix 2,
wherein the robot has a traveling axis as the drive axis, and
wherein the redundant axis is the traveling axis.

(Appendix 10) The robot system according to appendix 2,
wherein the robot is a vertical articulated robot, and
wherein the robot has seven or more drive axes as the plurality of drive axes, and
wherein the redundant axis is one of the seven or more drive axes.

(Appendix 11) The robot system according to appendix 2,
wherein the robot is two or more robots that operate cooperatively, and
wherein each of the two or more robots has one or more of the drive axes, and
wherein the redundant axis is the drive axis of one of the two or more robots in the cooperative operation.

(Appendix 12) A robot control method executable by a robot control system that controls a robot placed in a real working space and having a plurality of drive axes each having a degree of freedom for moving an end effector and includes at least one processor, the method comprising:
virtually executing a simulated posture of the robot at a designated point by a simulation based on a robot model indicating the robot;
determining a constraint condition of at least one of the plurality of drive axes at the designated point based on a degree of margin obtained from the simulated posture and a limit posture of the robot; and
controlling the robot based on the constraint condition.

(Appendix 13) A robot control program for causing a computer to function as a robot control system for controlling a robot placed in a real working space and having a plurality of drive axes each having a degree of freedom for moving an end effector, the program causing the computer to execute:
virtually executing a simulated posture of the robot at a designated point by a simulation based on a robot model indicating the robot;
determining a constraint condition of at least one of the plurality of drive axes at the designated point based on a degree of margin obtained from the simulated posture and a limit posture of the robot; and
controlling the robot based on the constraint condition.

What is claimed is:

1. A robot system comprising:
a robot placed in a real working space and having a plurality of drive axes each having a degree of freedom for moving an end effector; and
circuitry configured to:
set a designated point in a task;
virtually execute a simulated posture of the robot at the designated point by a simulation based on a robot model indicating the robot;
calculate a degree of margin indicating how far the simulated posture is from a limit posture of the robot;
determine a constraint condition of at least one of the plurality of drive axes at the designated point based on the calculated degree of margin; and
control the robot based on the constraint condition.

2. The robot system according to claim 1, wherein the circuitry is configured to control a position or posture of the robot such that the robot meets the constraint condition in the at least one drive axis.

3. The robot system according to claim 1,
wherein the plurality of drive axes includes a redundant axis, and
wherein the circuitry is configured to determine one position on the redundant axis as the constraint condition.

4. The robot system according to claim 1, further comprising a sensor configured to detect a real position of a workpiece present in the real working space as a workpiece position,
wherein the circuitry is configured to control the robot to process the workpiece, based on the constraint condition and the workpiece position detected by the sensor.

5. The robot system according to claim 4, wherein the circuitry is configured to:
adjust the designated point based on the workpiece position detected by the sensor; and
control the robot to process the workpiece, based on the adjusted designated point.

6. The robot system according to claim 5, wherein the circuitry is configured to generate a path for moving the end effector to the adjusted designated point.

7. The robot system according to claim 5, wherein the circuitry is configured to:
set a position where the end effector acts on the workpiece as the designated point; and
adjust the designated point based on a difference between coordinates of the designated point and coordinates of the workpiece position.

8. The robot system according to claim 1, further comprising a storage configured to store a task for processing a workpiece,
wherein the circuitry is configured to:
set a start position that is a position where the end effector starts to act on the workpiece in the task, as the designated point;
virtually execute a work scene in which the robot positions the end effector at the start position by the simulated posture to process the workpiece, by the simulation; and
determine the constraint condition for the end effector to act on the workpiece.

9. The robot system according to claim 8, wherein the circuitry is configured to:
virtually operate the robot such that the end effector passes through the start position and an end position in this order, and virtually execute the work scene, wherein the end position is a position where the action of the end effector on the workpiece ends in the task; and
calculate the degree of margin in the work scene based on a plurality of the degrees of margin in an area from the start position to the end position.

10. The robot system according to claim 9,
wherein the storage is configured to store two or more of the tasks, and
wherein the circuitry is configured to:
set the designated point for each of the two or more tasks;
virtually execute the work scene including the two or more tasks in a state where a position of each of the at least one of the plurality of drive axes is fixed at a common position that is a same position among the two or more tasks; and
determine the constraint condition common to the two or more tasks based on the degree of margin in each of the two or more tasks.

11. The robot system according to claim 3, wherein the circuitry is configured to:
virtually execute the simulated posture for each of a plurality of candidate positions set on the redundant axis;
calculate the degree of margin for each of the plurality of candidate positions based on the simulated posture for each of the plurality of candidate positions and the limit posture; and
determine one candidate position among the plurality of candidate positions as the constraint condition based on the degree of margin for each of the plurality of candidate positions.

12. The robot system according to claim 11, wherein the circuitry is configured to:
set each of the plurality of candidate positions by Bayesian optimization based on an evaluation value reflecting at least the degree of margin; and
virtually execute the simulated posture for each of the set plurality of candidate positions.

13. The robot system according to claim 11, wherein the circuitry is configured to determine, among the plurality of candidate positions, the one candidate position where the simulated posture farthest from the limit posture is obtained, as the constraint condition.

14. The robot system according to claim 1, wherein the circuitry is configured to calculate the degree of margin based on the simulated posture and a median of a movable range of each of the plurality of drive axes.

15. The robot system according to claim 1, wherein the circuitry is configured to calculate a manipulability ellipsoid based on the robot model and the simulated posture, and calculate the degree of margin based on the manipulability ellipsoid.

16. The robot system according to claim 3,
wherein the robot has a traveling axis as the drive axis, and
wherein the redundant axis is the traveling axis.

17. The robot system according to claim 3,
wherein the robot is a vertical articulated robot, and
wherein the robot has seven or more drive axes as the plurality of drive axes, and
wherein the redundant axis is one of the seven or more drive axes.

18. The robot system according to claim 3,
wherein the robot is two or more robots that operate cooperatively, and
wherein each of the two or more robots has one or more of the drive axes, and
wherein the redundant axis is the drive axis of one of the two or more robots in the cooperative operation.

19. A processor-executable method for controlling a robot placed in a real working space and having a plurality of drive axes each having a degree of freedom for moving an end effector, the method comprising:
setting a designated point in a task;
virtually executing a simulated posture of the robot at the designated point by a simulation based on a robot model indicating the robot;
calculating a degree of margin indicating how far the simulated posture is from a limit posture of the robot;
determining a constraint condition of at least one of the plurality of drive axes at the designated point based on the calculated degree of margin; and
controlling the robot based on the constraint condition.

20. A non-transitory computer-readable storage medium storing processor-executable instructions to cause a computer to function as a robot control system for controlling a robot placed in a real working space and having a plurality of drive axes each having a degree of freedom for moving an end effector, the instructions causing the computer to:
set a designated point in a task;
virtually execute a simulated posture of the robot at the designated point by a simulation based on a robot model indicating the robot;
calculate a degree of margin indicating how far the simulated posture is from a limit posture of the robot;
determine a constraint condition of at least one of the plurality of drive axes at the designated point based on the calculated degree of margin; and
control the robot based on the constraint condition.
